(19) United States
(12) Patent Application Publication
(10) Pub. No.: US 2014/0046869 A1
(43) Pub. Date: Feb. 13, 2014

(54) METHODS OF RATING AND DISPLAYING FOOD IN TERMS OF ITS LOCAL CHARACTER

(71) Applicant: Meghan Dear, Edmonton (CA)

(72) Inventor: Meghan Dear, Edmonton (CA)

(73) Assignee: Localize Services Ltd., Edmonton (CA)

(21) Appl. No.: 13/572,339

(22) Filed: Aug. 10, 2012

(51) Int. Cl. G06Q 30/00

(52) U.S. Cl. 705/347

(57) ABSTRACT

Methods of rating and ranking foods based on various dimensions of where food and food business has originated from are provided. In some embodiments, the methods can comprise scalable and strategic ways to increase the visibility of local food products in grocery stores or food service providers (such as restaurants). In some embodiments, this can be done through on-shelf, on-menu, or on-product labelling, a rating system for how local a food product is, a conventional URL (uniform resource locator) link and/or a quick-response link (a URL that a smart phone can scan) that can allow customers to pursue further information about a product from a point of sale or distribution. The link can lead to a website or other page destination (ie. such as through an app), that can provide a database of participating local food producers/processors who retail in grocery stores or supply restaurants and other food distributors.

### TECHNICAL FIELD

The present application relates to methods of rating foods and more particularly, methods of rating and ranking foods based on the various dimensions of where food and food business has originated from.

### BACKGROUND

By way of background, consumer demand for local food products has been growing consistently over the past 10 years. Grocery stores, restaurants, and other food service institutions have faced challenges in creating strategies that address the demand for these local products. Some of the challenges include defining what ‘local’ means, how to label and market local products in different regions, how to efficiently identify and source products that are geographically local, how to maintain up-to-date information about products, and how to create competitive pricing strategies for local products.

The demand for local food is not a passing fad, and is a credible issue for consumers, governments, and procurement departments. Consumers have demanded not only to have the access to more localized food products, they have also demanded to have clearer and more honest access to information about the background of retail food products.

While there is a significant growth in the so-called ‘locavore’ movement, there have been few or no complete products or services created that address the larger-scale retail grocery and food service industry (restaurant) demand for local products and the associated identification and marketing of these products.

Current local food initiatives work to develop physical warehousing, distribution, or direct sales from food producers to grocers. There remains to be a system which is effectively addressing the grocer or restaurant arena for identifying and labeling local food.

Certain systems appear to address the issue of labelling a food product as ‘local’ or ‘not local’, but there is not a reliable scoring method to answer the question and identify ‘how local?’ Some methods use food-miles which denote distance between production and retail, however, these systems are inefficient at describing the larger picture of ‘how local?’ a food product and their producer are. A hindrance to the identification of local products has been the quandary of how to label products with complexities that make them ‘less local’ in spite of having identifiable local attributes.

There remains a need to provide a method or system that can overcome the short comings of the prior art.

### SUMMARY

Methods of rating and ranking foods based on various dimensions of where food and food business has originated from are provided. In some embodiments, the methods can comprise scalable and strategic ways to increase the visibility of local food products in grocery stores or food service providers (restaurants). In some embodiments, this can be done through on-shelf, on-menu, or on-product labelling, a rating system for how local a food product is, a conventional URL (uniform resource locator) link and/or a quick-response link (a URL that a smart phone can scan) that can allow customers to pursue further information about a product from a point of sale or distribution. The link can lead to a website or other location (such as an app) that can provide a database of participating local food producers/processors who retail in grocery stores or supply restaurants and other food distributors.

In some embodiments, the present methods can have the effect of partnering a local food ranking organization with food manufacturers, grocers, food service providers (restaurants), and consumers in order to identify the various dimensions of where food and food business has originated from and how far that origination is from the consumer. In some embodiments, labels (such as shelf labels, menu labels, or product labels) and other identification materials can be provided to retail establishments like grocers and restaurants. The labels can be placed proximate a food product and indicate a total rating score of localness of the product. Such scoring and labelling can be applied to any food product in any grocery store, restaurant, or anywhere that food is prepared/served including institutions like schools, hospitals, cafeterias, catering, etc.

The labels can also comprise a readable code that can link a consumer to a total rating score of localness and other data about the food product. Data can be kept up to date through integration with retail point of sale systems, user generated data, crowd sourced data, and individual interviews. The database of food product information can have the capacity to grow and be a significant resource of food information. The database can also provide highly specific purchase/sale recommendations for an individual consumer, individual grocery store outlets, food service providers, food distributors, and institutional or corporate level buyers.

The rating system of the present methods can shift the mentality of marketing local from ‘Is something local or not?’ towards ‘How local?’ and ‘What is most local?’ this can allow the debate about ‘what local means’ to be ameliorated by shifting the conversation to ‘How local is it?’ The present methods can allow for a clearer articulation of where food has come from in multiple dimensions. These dimensions can include the location of production, location of processing, where ingredients were grown and sourced from, how the food was made or produced, what business produced it, where that business is owned, and how local value chains were utilized.

Broadly stated, in some embodiments, a method of rating a food supplied from a company as to how local it is to a point of delivery to a consumer is provided, the method comprising: assessing a degree of local ownership of the company; assessing a degree of local food production or local processing of the food; assigning a score to each assessment; and combining each score into a total rating; wherein the total rating is an amount that exists on a sliding scale and can be compared to total ratings of other food.

Broadly stated, in some embodiments, a general-purpose computer for implementing a method of rating a food supplied from a company as to how local it is to a point of delivery to a consumer is provided, comprising: means for assessing a degree of local ownership of the company; means for assessing a degree of local food production or local processing of the food; means for assigning a score to each assessment; and means for combining each score into a total rating; wherein the total rating is an amount that exists on a sliding scale and can be compared to total ratings of other food.

Broadly stated, in some embodiments, a food label is provided, comprising a display surface showing a food total rating resulting from implementing of the method of rating a food supplied from a company as to how local it is to a point of delivery to a consumer is provided, the method comprising: assessing a degree of local ownership of the company; assessing a degree of local food production or local processing of the food; assigning a score to each assessment; and combining each score into a total rating; wherein the total rating is an amount that exists on a sliding scale and can be compared to total ratings of other food.

### BRIEF DESCRIPTION OF THE DRAWINGS

FIG. 1 is a chart depicting an embodiment of a method for rating and ranking foods based on the various dimensions of where food and food businesses have originated from that can be used for food growers and their food product.

FIG. 2 is a chart depicting an embodiment of a method for rating and ranking foods based on the various dimensions of where food and food businesses have originated from that can be used for food processors and their food product.

FIG. 3 depicts an embodiment of a food labelling system incorporating a method for rating and ranking foods based on the various dimensions of where food and food businesses have originated from.

### DETAILED DESCRIPTION OF EMBODIMENTS

Methods of rating and ranking foods based on various dimensions of where food and food business has originated from are provided. In some embodiments, the methods can comprise scalable and strategic ways to increase the visibility of local food products in grocery stores or food service providers (restaurants). In some embodiments, this can be done through on-shelf, on-menu, or on-product labelling, a rating system for how local a food product is, a conventional URL (uniform resource locator) link and/or a quick-response link (a URL that a smart phone can scan) that can allow customers to pursue further information about a product from a point of sale or distribution. The link can lead to a website or other page destination (ie. such as through an app), that can provide a database of participating local food producers/processors who retail in grocery stores or supply restaurants and other food distributors.

Such scoring/rating and labelling can be applied to any food product in any grocery store, restaurant, or anywhere that food is prepared/served including institutions like schools, hospitals, cafeterias, catering, etc.

In some embodiments, of the present method, different aspects/dimensions/factors of a food or food company can be identified/measured/assessed in order to rate or rank the product on a scale of how local the product is. In some embodiments, among other things, the location of business ownership, location of production, location of processing, source of ingredients, and/or sustainability of the product/company can be examined. Location of production can refer to where a primary product is grown. For example, where a cow is raised or where a carrot is grown. Location of processing can refer to a stage where a processed product is created (not grown). This is where food is mixed, roasted, packaged, fried, canned, baked, dried, pressed, etc. For example, location of processing might refer to where perogies are made. Source of ingredients can refer to the location of growing/raising/production of a primary product which is an ingredient in a processed product.

In some embodiments assessing a degree of local food production or local processing of the food can comprise asking ‘Where is the product grown or raised?’ or ‘Where is the product processed?’ and can be measured/scored based on geography. By contrast, this step does not comprise asking ‘Who produced the product?’ and scored based on whether the product is made by the seller or resold.

It is contemplated that different aspects/dimensions/factors of a food or food company can be identified/measured/assessed in order to rate or rank the product on a scale of how local the product is, including the location and number of jobs created, supply chains (in addition to ingredients), packaging impact, distribution channels, and also weighting assessments according to a percentage dollar value of the ingredients to the total dollar value of the product.

As would be understood by one skilled in the art, the information used to measure/assess/rank/rate any of these aspects/dimensions/factors can be collected in any variety of reliable manners from any variety of reliable sources or combination of sources such as, but not limited to, public records, searchable databases, and/or voluntarily provided information. In some embodiments, information can be collected from producers/processors via an initial questionnaire, and then with a follow-up interview. For more complex situations, batch recipes of products can be reviewed in detail to provide a best-case and worst-case assessment and rating. For example, the percentage make-up of ingredients in a food product can be assessed and the information regarding the source of those ingredients can be collected and used to provide a weighted rating.

Information can be collected through a structured questionnaire, which can use both open and closed questions to ascertain each of the criteria making up a ranking/rating score. On-phone or in-person interviews can also be used to clarify and confirm the make-up of a score. As the information being collected can change as the product or company changes, re-assessments can also be performed at an appropriate interval, for example on a quarterly basis to re-verify the information. Food companies such as producers or processors can also voluntarily provide information regarding a change of circumstances. In some embodiments, web-based or cloud-based systems can be used to manage the information and can allow both the data-collector and the food company to access and confirm or update information.

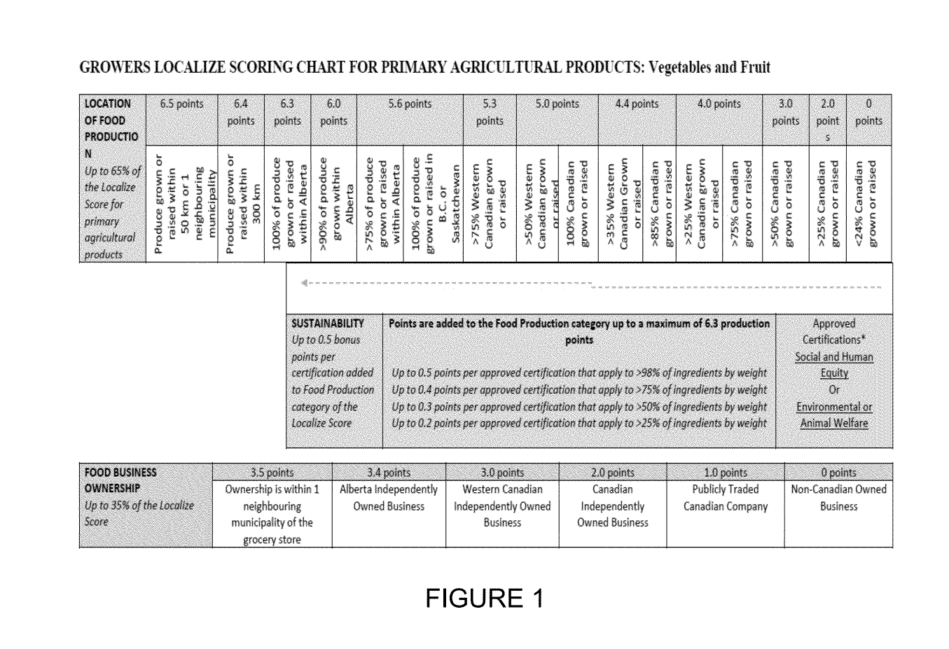

Referring to FIG. 1, an embodiment of the method is shown that can rate and rank foods based on the various dimensions of where food and food businesses have originated from. Although FIG. 1 demonstrates an example of a scoring chart that compares aspects of a food product for a consumer and point of sale/distribution in Edmonton, Alberta, Canada, in relation to other geographical regions, it would be appreciated by one skilled in the art that any geographical starting point could be used and the relation to other geographical regions can be adjusted to that particular starting point.

In some embodiments, the present method can be used for rating and ranking food products from food growers, for example primary agricultural products such as vegetables and fruit. In some embodiments, both the location of food production and the location of the food business ownership can be assessed and ranked to determine values. These values can then be combined to provide a rating total (total rating score).

In some embodiments, an assessment of location of food production can be made on a point scale of up to 6.5 points, although it would be appreciated that the total number and intervals in between the points can be arbitrary but can serve to demonstrate a difference in one score to another in relative terms. As an example only: 6.5 points can be awarded if the product is grown or raised within 50 km or 1 neighboring municipality of the point of sale; 6.4 points can be awarded if the product is grown or raised within 300 km of the point of sale; 6.3 points can be awarded if the product is 100% grown or raised within the same province/state/territory as the point of sale; 6.0 points can be awarded if the product is >90% grown or raised within the same province/state/territory as the point of sale; 5.6 points can be awarded if the product is >75% grown or raised within the same province/state/territory as the point of sale OR 100% grown or raised in a neighbouring province/state/territory of the point of sale; 5.3 points can be awarded if the product is >75% grown or raised in a neighbouring province/state/territory of the point of sale; 5.0 points can be awarded if the product is >50% grown or raised in a neighbouring province/state/territory of the point of sale OR 100% grown or raised in the same country, but outside of a neighbouring province/state/territory, as the point of sale; 4.4 points can be awarded if the product is >35% grown or raised in a neighbouring province/state/territory of the point of sale OR>85% grown or raised in the same country, but outside of a neighbouring province/state/territory, as the point of sale; 4.0 points can be awarded if the product is >25% grown or raised in a neighbouring province/state/territory of the point of sale OR>75% grown or raised in the same country, but outside of a neighbouring province/state/territory, as the point of sale; 3.0 points can be awarded if the product is >50% grown or raised in the same country, but outside of a neighbouring province/state/territory, as the point of sale; 2.0 points can be awarded if the product is <50% but >25% grown or raised in the same country, but outside of a neighbouring province/state/territory, as the point of sale; or 0.0 points can be awarded if the product is <24% grown or raised in the same country, but outside of a neighbouring province/state/territory, as the point of sale.

In some embodiments, an assessment of food business ownership can be made on a point scale of up to 3.5 points, although it would be appreciated that the total number and intervals in between the points can be arbitrary but can serve to demonstrate a difference in one score to another in relative terms. As an example only: 3.5 points can be awarded if the company ownership is located within one neighbouring municipality of the point of sale; 3.4 points if the company is independently owned within the same province/state/territory, but outside of one neighbouring municipality, as the point of sale; 3.0 points if the company is independently owned within a neighbouring province/state/territory of the point of sale; 2.0 points if the company is independently owned within the same country, but outside of one neighbouring province/state/territory, as the point of sale; 1.0 points if the company is a publically traded company within the same country as the point of sale; or 0 points if the company is owned outside of the same country as the point of sale. Some embodiments of the present method can award extra points to independent businesses (ie. not publically traded businesses).

In some embodiments, the sustainability of the food product/company can also be assessed and given a score. A measure of sustainability can be incorporated into the method under the assessment of location of food production, for example by adding bonus points to the food production category. Sustainability information can be collected, assessed, and rated/ranked in any manner as would be known by one skilled in the art.

In some embodiments, sustainability can be assessed based upon relevant certifications obtained by the food producer, food product, and/or food ingredient (even if the product at large is not certified). In an example where the total rating score is out of 10.0, up to 0.5 bonus points per certification can be added to the food production category of the total rating score. A certification can be any certification of relevance and interest, for example, approved certifications from third party certifiers such as Fair Trade, Certified Organic, Sea Choice, Rainforest Alliance, OceanWise Certification, MSC Certification, Certified Local Sustainable, Cafe Feminino Certification, SPCA Certification, or other certifications that qualify to improve Social and Human Equity or Environmental or Animal Welfare. The present methods can provide a way to improve the visibility and importance of these types of certifications and sustainability in general.

In some embodiments, an assessment of sustainability can be made on a point scale of up to 0.5 bonus points per certification added to the food production category of the total rating score up to a maximum of 6.3 production points, although it would be appreciated that the total number and intervals in between the points can be arbitrary but can serve to demonstrate a difference in one score to another in relative terms. As an example only: up to 0.5 points can be awarded per approved certification that apply to >98% of the product ingredients by weight; up to 0.4 points per approved certification that apply to >75% of ingredients by weight; up to 0.3 points per approved certification that apply to >50% of ingredients by weight; or up to 0.2 points per approved certification that apply to >25% of ingredients by weight.

In some embodiments, each score assigned from each assessment of the aspects/dimensions/factors can be combined into a rating total (total score, total rating score). As an example only: location of food production can comprise up to 65% (6.5/10.0) of the rating total for primary agricultural products and food business ownership can comprise up to 35% (3.5/10.0) of the rating total, making 100% (10.0/10.0) total. In addition, sustainability can be scored on a point scale of up to 5% (0.5/10.0) bonus points per certification added to the food production category of the rating total up to a maximum of 63% (6.3/10.0) production points.

Although the example shown in FIG. 1 uses a 10 point scale system, it would be appreciated that any sliding scale which allows a consumer to compare a score of one product to another could be used, for example, a 5 point scale, a 1 point decimal scale, a percentage scale, a thousand point scale, a letter score, a school-grading type score, etc.

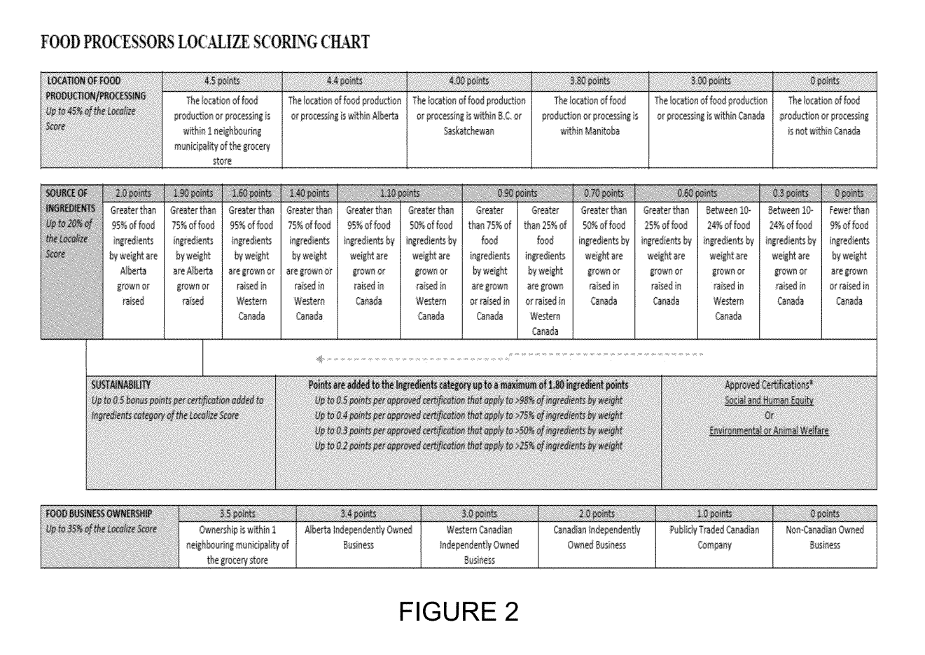

Referring to FIG. 2, an embodiment of the method is shown that can rate and rank foods based on the various dimensions of where food and food businesses have originated from. Although FIG. 2 demonstrates an example of a scoring chart that compares aspects of a food product for a consumer in Edmonton, Alberta, Canada, in relation to other geographical regions, it would be appreciated by one skilled in the art that any geographical starting point could be used and the relation to other geographical regions can be adjusted to that particular starting point.

In some embodiments, the present method can be used for rating and ranking food products from food processors. In addition to assessing both the location of food production and the location of the food business ownership, the source of ingredients can also be assessed and ranked to determine a value/score. This value can then be combined with the other values/scores to provide a rating total (total rating score).

In some embodiments, an assessment of location of food production/processing can be made on a point scale of up to 4.5 points, although it would be appreciated that the total number and intervals in between the points can be arbitrary but can serve to demonstrate a difference in one score to another in relative terms. As an example only: 4.5 points can be awarded if the location of food production or processing is within 1 neighboring municipality of the point of sale; 4.4 points can be awarded if the location of food production or processing is within the same province/state/territory as the point of sale; 4.0 points can be awarded if the location of food production or processing is within a neighbouring province/state/territory of the point of sale; 3.8 points can be awarded if the location of food production or processing is within a neighbour of a neighbouring province/state/territory of the point of sale; 3.0 points can be awarded if the location of food production or processing is within the same country, but outside of a neighbour of a neighbouring province/state/territory, as the point of sale; or 0.0 points can be awarded if the location of food production or processing is not within the same country as the point of sale.

In some embodiments, an assessment of the source of ingredients can be made on a point scale of up to 2.0 points, although it would be appreciated that the total number and intervals in between the points can be arbitrary but can serve to demonstrate a difference in one score to another in relative terms. As an example only: 2.0 points can be awarded to a food product if >95% of food ingredients by weight are grown or raised in the same province/state/territory as the point of sale; 1.90 points can be awarded to a food product if >75% of food ingredients by weight are grown or raised in the same province/state/territory as the point of sale; 1.60 points can be awarded to a food product if >95% of food ingredients by weight are grown or raised within a neighbouring province/state/territory of the point of sale; 1.40 points can be awarded to a food product if >75% of food ingredients by weight are grown or raised within a neighbouring province/state/territory of the point of sale; 1.10 points can be awarded to a food product if >95% of food ingredients by weight are grown or raised within the same country, but outside of a neighbouring province/state/territory, as the point of sale OR>50% of food ingredients by weight are grown or raised within a neighbouring province/state/territory of the point of sale; 0.90 points can be awarded to a food product if >75% of food ingredients by weight are grown or raised within the same country, but outside of a neighbouring province/state/territory, as the point of sale OR>25% of food ingredients by weight are grown or raised within a neighbouring province/state/territory of the point of sale; 0.70 points can be awarded to a food product if >50% of food ingredients by weight are grown or raised within the same country, but outside of a neighbouring province/state/territory, as the point of sale; 0.60 points can be awarded to a food product if >25% of food ingredients by weight are grown or raised within the same country, but outside of a neighbouring province/state/territory, as the point of sale OR between 10-24% of food ingredients by weight are grown or raised within a neighbouring province/state/territory of the point of sale; 0.3 points can be awarded to a food product if between 10-24% of food ingredients by weight are grown or raised within the same country, but outside of a neighbouring province/state/territory, as the point of sale; or 0.0 points can be awarded to a food product if <9% of food ingredients by weight are grown or raised within the same country, but outside of a neighbouring province/state/territory, as the point of sale.

In some embodiments, an assessment of food business ownership can be made on a point scale of up to 3.5 points, although it would be appreciated that the total number and intervals in between the points can be arbitrary but can serve to demonstrate a difference in one score to another in relative terms. As an example only: 3.5 points can be awarded if the company ownership is located within one neighbouring municipality of the point of sale; 3.4 points if the company is independently owned within the same province/state/territory, but outside of one neighbouring municipality, as the point of sale; 3.0 points if the company is independently owned within a neighbouring province/state/territory of the point of sale; 2.0 points if the company is independently owned within the same country, but outside of one neighbouring province/state/territory, as the point of sale; 1.0 points if the company is a publically traded company within the same country as the point of sale; or 0.0 points if the company is owned outside of the same country as the point of sale. Some embodiments of the present method can award extra points to independent businesses (ie. not publically traded businesses).

In some embodiments, the sustainability of the food product/company can also be assessed and given a score. A measure of sustainability can be incorporated into the method under the assessment of location of food production, for example by adding bonus points to the food production category. Sustainability information can be collected, assessed, and rated/ranked in any manner as would be known by one skilled in the art.

In some embodiments, sustainability can be assessed based upon relevant certifications obtained by the food producer, food product, and/or food ingredient (even if the product at large is not certified). In an example where the total rating score is out of 10.0, up to 0.5 bonus points per certification can be added to the food production category of the total rating score. A certification can be any certification of relevance and interest, for example, approved certifications from third party certifiers such as Fair Trade, Certified Organic, Sea Choice, Rainforest Alliance, OceanWise Certification, MSC Certification, Certified Local Sustainable, Cafe Feminino Certification, SPCA Certification, or other certifications that qualify to improve Social and Human Equity or Environmental or Animal Welfare. The present methods can provide a way to improve the visibility and importance of these types of certifications and sustainability in general.

In some embodiments, an assessment of sustainability can be made on a point scale of up to 0.5 bonus points per certification added to the food production category of the total rating score up to a maximum of 1.8 production points, although it would be appreciated that the total number and intervals in between the points can be arbitrary but can serve to demonstrate a difference in one score to another in relative terms. As an example only: up to 0.5 points can be awarded per approved certification that apply to >98% of the product ingredients by weight; up to 0.4 points per approved certification that apply to >75% of ingredients by weight; up to 0.3 points per approved certification that apply to >50% of ingredients by weight; or up to 0.2 points per approved certification that apply to >25% of ingredients by weight.

In some embodiments, each score assigned from each assessment of the aspects/dimensions/factors can be combined into a rating total (total score, total rating score. As an example only: location of food production can comprise up to 45% (4.5/10.0) of the rating total for processed food products, the source of ingredients can comprise up to 20% (2.0/10.0) of the rating total, and food business ownership can comprise up to 35% (3.5/10.0) of the rating total, making 100% (10.0/10.0) total. In addition, sustainability can be scored on a point scale of up to 0.5 (0.5/10.0) bonus points per certification added to the source of ingredients category of the rating total, up to a maximum of 1.8 (1.8/10.0) ingredient points.

Although the example shown in FIG. 1 uses a 10 point scale system, it would be appreciated that any sliding scale which allows a consumer to compare a score of one product to another could be used, for example, a 5 point scale, a 1 point decimal scale, a percentage scale, a thousand point scale, a letter score, a school-grading type score, etc.

In some embodiments, the present rating methods can be aligned with current government standards for regulatory definitions of local, and/or with popular understandings and sentiments of what the term local means. The latter can be developed from crowd-sourcing activity collecting survey data to break down the specific weightings/dimensions/criteria for rating. In some embodiments, the present rating methods can be further adapted to other local/regional/national requirements for the labeling of local, and/or adapted according to local sentiments about what local means (for example, people in one geographic region may have a different perception of local than a different region).

In some embodiments, a general-purpose a specific-purpose computer can be used for implementing the methods of the present disclosure. The computer can comprise means for performing the steps of the method as would be known by one skilled in the art. For example, the computer can comprise means for assessing a degree of local ownership of the company; means for assessing a degree of local food production or local processing of the food; means for assigning a score to each assessment; and means for combining each score into a total rating; wherein the total rating is an amount that exists on a sliding scale and can be compared to total ratings of other food.

In some embodiments, a computer readable medium can be used for implementing the methods of the present disclosure. The computer readable medium can comprise means for performing the steps of the method as would be known by one skilled in the art. For example, the computer readable medium can comprise means for assessing a degree of local ownership of the company; means for assessing a degree of local food production or local processing of the food; means for assigning a score to each assessment; and means for combining each score into a total rating; wherein the total rating is an amount that exists on a sliding scale and can be compared to total ratings of other food.

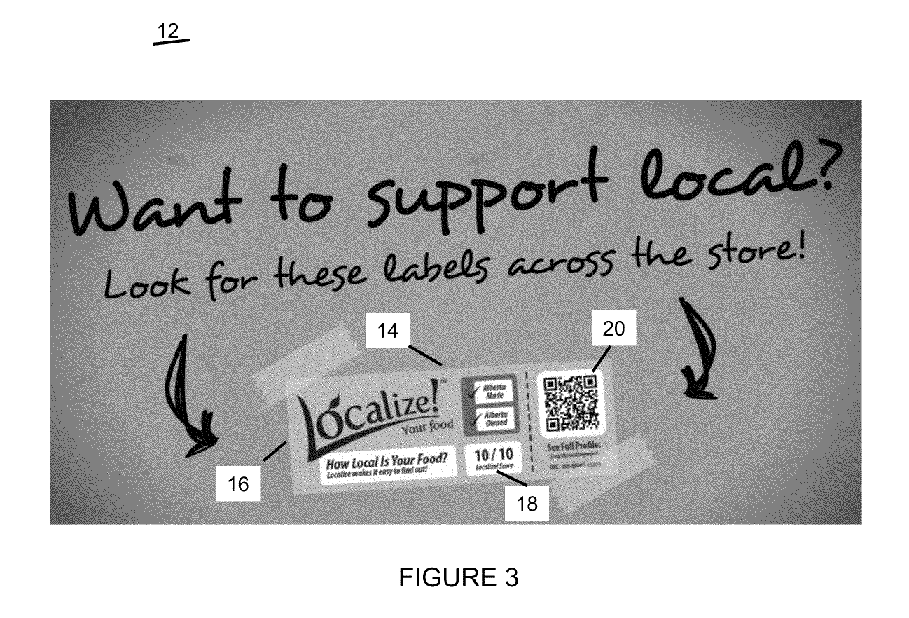

Referring now to FIG. 3, an embodiment of a food label and a food labelling system incorporating a method for rating and ranking foods based on the various dimensions of where food and food business has originated from is depicted. Although the embodiment depicted in FIG. 3 generally relates to an example for use in the grocery context, it would be understood by one skilled in the art that the food label and a food labelling system can be adapted to other food service providers such as restaurants and other institutions.

In some embodiments, banner advertisements 12 can be used in a store to alert a customer that a rating and ranking system for local foods is being used in that store. In some embodiments, banner advertisements 12 can comprise a depiction of a shelf label 14. Shelf labels 14 can be placed on a store's shelf, proximate a food item which has been rated. As would be understood by one skilled in the art, shelf label 14 can comprise a variety of configurations and can be created to complement or replace existing shelf labels at a store and can be affixed in any appropriate manner to the store shelves. Shelf labels 14 can be re-issued and on-shelf within a short time of any store inventory changes or changes to food product or food processor ingredients. For example, labels can be automatically regenerated if a grocer shifts from an apple grower from one province/state/territory to an apple grower from a different province/state/territory. As a different example, labels can be automatically regenerated if a BBQ sauce maker from one province/state/territory changes from sourcing tomatoes grown in their own province/state/territory towards sourcing tomatoes from a warmer province/state/territory in the winter.

In some embodiments, shelf labels 14 can comprise a branding portion 16 where information about the food product and/or the rating system can be displayed. In some embodiments, shelf labels 14 can comprise a display area for a total rating score 18 for that food product. Total rating score 18 can be arrived at, for example, by using methods according to the present disclosure.

In some embodiments, shelf labels 14 can comprise an information code 20. Information code 20 can comprise a computer readable code such as a Universal Product Code (UPC) or a quick-response link (QR code). Information contained in that code might be a URL, a UPC, or any other unique product identifier or product information. In some embodiments, information code 20 can directly embed the necessary product and rating information for retrieval by a consumer instead of indirectly linking to that information held on a server or cloud.

Information code 20 can be read, for example scanned or photographed by a general purpose computer or a smartphone, in such a manner as to link the user of the general purpose computer or a smartphone to information about the food product. This linkage can be performed wirelessly, via the internet, to on-line information regarding the food product. The on-line information can be hosted by the food rating provider and can include a detailed report of the rating assessment and background information for a food product. The on-line information can updated remotely and include new information or changes that may not be reflect in total rating score 18 presently printed on shelf label 14. In some embodiments, the on-line information can be updated in real-time/just-in-time while the shelf label can be updated periodically.

As would be apparent to one skilled in the art, the present methods, labels, and labelling systems have the potential to increase sales of local food items as well as other items at grocers or restaurants (using rating labels on menus). With the demand for local food increasing consumers are likely to be attracted to vendors that use a system that provides easy and reliable information about ‘how local’ a food item is. Food businesses can use the present methods as a way to distinguish themselves from their competition according to their ability to be transparent and to be recognized according to their locality of production, processing, ownership, and sustainable practices. The present methods can also incentivise grocers and food service providers to support local and independent food producers through both the gain in value of those products on store shelves or menu items, through the social recognition that grocers/restaurants can receive through the methods, and through the simplification of identifying ‘most local’ food products across any category.

In some embodiments, the present rating methods and labels can comprise the incorporation of the local rating metrics with existing store metrics to track store progress and results. In some embodiments, this integration, and the results therefrom, can be embodied as corporate scorecards.

Without any limitation to the foregoing, the present method is further described by way of the following examples.

### Example 1

Company A sells Product A which is 100% honey from their own farm in Town A. Company A is owned in Town A, Province A and does all processing in Town A, Province A. As such, the honey product rates a 10/10 to a consumer in the Town A area, and will rate a 9.8/10 throughout Province A.

Ownership: Town A, Province A, Country A

The ownership will rate a 3.4/3.5 because it is a Province A owned, independent business. If Product A was purchased in Town A or within a neighbouring municipality it will rate a full 3.5/3.5.

Processing: Town A, Province A, Country A

All processing is done in Town A, giving it a score of 4.4/4.5. If Product A was purchased in Town A or within a neighbouring municipality it will rate a full 4.5/4.5.

Source of Ingredients:

All honey comes from the Town A farm. They do not blend honey from other farms. Some honey products are flavoured, however flavourings account for under 1% of the product by weight and volume.

As such, Product A would receive a total rating score of 9.8/10 if purchased at a vendor in Province A (outside of Town A or neighbouring municipalities) or 10/10 if purchased within Town A or a neighbouring municipality.

If Product A honey did blend other honey, such as honey from another country, the proportions of foreign to domestic ingredients would be assessed and could lead to fewer points in the ingredients category. Product A would still be awarded points for the honey they do produce on the farm in Town A and for their ownership and processing characteristics.

### Example 2

Company B is a goat dairy providing Product B that has the following profile for ‘localness’. Some embodiments of the present method rate that level of localness based on a sliding scale of each of three criteria for food processors.

In this example, the point of sale vendor and the consumer are located in Town A, Province A, Country A.

Company B Ownership: Town B, Province B, Country A

The ownership will rate a 3.0/3.5 because it is a Province B (neighbour of Province A) owned, independent business. If it was a Province A owned business it would rate at least a 3.4/3.5.

Processing of the milk: Town B, Province B and/or Town A, Province A.

All of the milk sold in Province A is processed in Town A, Province A, so they score a 4.4/4.5.

Production of the milk: Farms from Province A and Province B.

The source of milk itself may vary through the year, with a supplementation of up to 20% Province B milk when Province A supplies are low. At its peak Product B is 100% Province A milk.

Peak rating is 9.4/10 (or 9.5/10 if purchased within a municipality of the processing plant), lowest rating is 9.0/10.

Other prior art labeling/identification pursuits could be conceptually restricted in how Product B is labeled. For example: Product B might qualify for ‘Product of Country A’ labeling, but this would not articulate the specific elements that made it local or more/less local relative to where it was made or processed in Country A.

Since the processing of Product B is local to Province A when sold in Province A, but the milk source may or may not be local to Province A, existing government definitions of local might not have the fidelity to identify this product as local or not local.

Product B might be identified in stores as a Province A product, however that is confusing given the non-Province A ownership and possibility of mixture with Province B milk.

Local food campaigns tend to be fraught with inconsistencies. A campaign like that currently used at certain grocers in Province A, would not identify this product as local because they label only Province A owned businesses (even though the milk is from Province A independent dairies). Product B serves as a good example of a product that may or may not be labeled as ‘local’ by prior art methods. The consumer requires a clearer articulation of what part of Product B makes it local and in which circumstances.

### Example 3

Company C makes inexpensive frozen meals like lasagna or macaroni and cheese (Product C). They are owned and operated in City C, Province A. Their ingredients range from cheese that is made in Province B, flour sourced from a Province A mill, and beef that is Province A grown.

In this example, the point of sale vendor and the consumer are located in City C, Province A, Country A.

Ownership: City C, Province A, Country A.

The ownership will rate a 3.4/3.5 because it is a Province A owned, independent business. If Product C is purchased in City C it will rate a full 3.5/3.5.

Processing: City C, Province A, Country A.

All processing is done in City C, giving it a score of 4.4/4.5 for sales/purchases of Product C in Province A, but outside of City C or a neighbouring municipality of City C. If Product C was purchased in City C it will rate a full 4.5/4.5.

Source of Ingredients: Varies respectively for each type of lasagna and macaroni and cheese product. Each product has a different set of ingredients and each are assessed and evaluated against the Source of Ingredients score.

Peak total rating score is 9.8/10 for Province A (or 10/10 if purchased within City C or a neighbouring municipality of City C) for their macaroni and cheese product. Lowest rating is 8.4/10 for a vegetarian lasagna with ingredients sourced from outside of Province A.

Company C creates a mass-produced product that would not typically be considered local. However the major competing product in the same price category is made in Country B. As such, displaying Product C as having a certain degree of local character helps the consumer make an informed decision and creates a greater benefit for the local economy. It can also incentivise Company C to source more ingredients locally because of the respective recognition and improved scoring.

### Example 4

Company D produces coffee beans (Product D). Coffee beans are exotic and not grown in Country A, but there are an abundance of smaller local roasteries that process the coffee as a product. Typically there is about 1 independent coffee roasterie represented for every 9 large corporate roasters.

In this example, the point of sale vendor and the consumer are located in City C, Province A, Country A.

Company D Ownership: Town D, Province A, Country A

The ownership will rate a 3.4/3.5 because it is a Province A owned, independent business. If Product D was purchased in Town D, or a neighbouring municipality, it will rate a full 3.5/3.5.

Processing: Town D, Province A, Country A

All roasting is done in Town D, giving it a score of 4.4/4.5. If Product D was purchased in Town D, or a neighbouring municipality, it will rate a full 4.5/4.5.

Source of Ingredients: Varies by product

Company D sources from Country C and Country D sources, giving it a score of 0/2.0 for ingredients.

Sustainability (bonus) points are re-awarded for the ingredients because they are sourced from certified Fair Trade and certified Rainforest Alliance sources, giving a score of 1.0/2.0 for ingredients.

As such, Product D can be rated with a total ranking score of 8.8/10 (or 9.0 if purchased within Town D or a neighbouring municipality of Town D).

### Example 5

Company E makes a sports energy drink (Product E). The company is owned in Town E, Province B, Country A. Product E has strong branding implying a connection with Country A, and contains some ingredients from Country A.

In this example, the point of sale vendor and the consumer are located in City C, Province A, Country A.

Company E Ownership: Town E, Province B, Country A.

The ownership will rate a 3.0/3.5 because it is a Province B owned, independent business.

Processing: Country B

All processing is done in Country B, giving it a processing score of 0.0/4.5

Source of Ingredients:

Some of their flavorings and additives for Product A come from Country A, including syrup from Province C, Country A. Since these Country A ingredients constitute 15% of the total product by weight, they score a 0.3/2.0.

The total rating score for Product E is 3.3/10.

### Example 6

Company F sells pickles (Product F). In this example, the point of sale vendor and the consumer are located in City C, Province A, Country A.

Company F Ownership: Town F, Province D, Country A.

The ownership will rate a 2.0/3.5 because it is a Country A owned, independent business.

Processing: Town F, Province D, Country A.

All processing is done by Company F on their farm processing facility, in Province D, Country A giving them a 3.0/4.5 (Province D does not Neighbor Province A).

Source of Ingredients:

Company F grows all of their own pickles, except under rare circumstances. Unless otherwise notified, their 100% Province D, Country A food ingredients give them a 1.1/2.0.

Sustainability:

Company F has a partially certified organic acreage. They have two product lines that are called ‘natural’ (no extra points for sustainability) and certified ‘organic’ (0.5 extra points for sustainability).

The total rating score for Product F is 6.1/10 for ‘natural’ pickles and 6.6/10 for ‘organic’ pickles.

Embodiments disclosed herein can be implemented as one or more computer program products, i.e., one or more modules of computer program instructions encoded on a computer-readable medium for execution by, or to control the operation of, data processing apparatus. For example, logic or software operable to carry out the food rating and ranking methods disclosed herein may be provided in such computer-readable medium of a computer and executed by a corresponding processor or processing engine (not shown). The computer-readable medium can be a machine-readable storage device, a machine-readable storage substrate, a non-volatile memory device, a composition of matter affecting a machine-readable propagated signal, or a combination of one or more of them. In this regard, the computer may encompass one or more apparatuses, devices, and machines for processing data, including by way of example a programmable processor, a computer, or multiple processors or computers. In addition to hardware, the computer may include code that creates an execution environment for the computer program in question, e.g., code that constitutes processor firmware, a protocol stack, a database management system, an operating system, or a combination of one or more of them.

A computer program (also known as a program, software, software application, script, or code) used to provide any of the functionalities described herein can be written in any appropriate form of programming language including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit). Processors suitable for the execution of a computer program may include, by way of example, both general and special purpose microprocessors, and any one or more processors of any kind of digital computer. Generally, a processor will receive instructions and data from a read-only memory or a random access memory or both. Generally, the elements of a computer are one or more processors for performing instructions and one or more memory devices for storing instructions and data. The techniques described herein may be implemented by a computer system configured to provide the functionality described.

The scope of the claims should not be limited by the embodiments as set forth in the examples herein, but should be given the broadest interpretation consistent with the description as a whole.

Although a few embodiments have been shown and described, it will be appreciated by those skilled in the art that various changes and modifications can be made to the embodiments described herein. The terms and expressions used in the above description have been used herein as terms of description and not of limitation, and there is no intention in the use of such terms and expressions of excluding equivalents of the features shown and described or portions thereof, it being recognized that the invention is defined and limited only by the claims that follow.

The teachings provided herein can be applied to other methods, not necessarily the method described herein. The elements and acts of the various embodiments described above can be combined to provide further embodiments.

These and other changes can be made to the invention in light of the above description. While the above description details certain embodiments of the invention and describes certain embodiments, no matter how detailed the above appears in text, the invention can be practiced in many ways. Details of the method may vary considerably in their implementation details, while still being encompassed by the invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification. Accordingly, the actual scope of the invention encompasses not only the disclosed embodiments, but also all equivalent ways of practicing or implementing the invention.

The above description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. The elements and acts of the various embodiments described above can be combined to provide further embodiments.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

I claim:

1. A method of rating a food supplied from a company as to how local it is to a point of delivery to a consumer, the method comprising:
a) assessing a degree of local ownership of the company;
b) assessing a degree of local food production or local processing of the food;
c) assigning a score to each assessment; and
d) combining each score into a total rating;
wherein the total rating is an amount that exists on a sliding scale and can be compared to total ratings of other food.

2. The method of claim 1, further comprising a step assessing the degree of local sources of ingredients and assigning a score to this assessment to be combined with the scores from the other assessment to provide the total.

3. The method of claim 2, further comprising a step of assessing the sustainability of the food and assigning a score to this assessment to be combined with the scores from the other assessment to provide the total.

4. The method of claim 1 further comprising the steps of providing the total rating of the food on a food label and linking the total rating of the food from the food label to the consumer.

5. The method of claim 4 wherein the linking is performed by an information code on the label to be scanned by the consumer using a scanning device.

6. The method of claim 5 wherein the information code comprises a QR code.

7. The method of claim 4 wherein the labels are grocer labels displayed of grocery shelves.

8. The method of claim 4 wherein the labels are menu labels displayed on a menu of a food service provider.

9. The method of claim 1 further comprising the step of periodically reassessing each criteria to produce reassessed scores thereby creating a reassessed total.

10. The method of claim 1, further comprising a step of assessing the sustainability of the food and assigning a score to this assessment to be combined with the scores from the other assessment to provide the total.

11. A food label comprising a display surface showing a food total rating resulting from implementing of the method of claim 1.

12. The food label of claim 11 further comprising means for linking the total rating of the food from a food label to a consumer.

13. The food label of claim 12 wherein the linking means comprises an information code on the label to be scanned by a consumer using a scanning device.

14. The food label of claim 13 wherein the information code comprises a QR code.

15. A general purpose computer for implementing a method of rating a food supplied from a company as to how local it is to a point of delivery to a consumer, the computer comprising:
a) means for assessing a degree of local ownership of the company;
b) means for assessing a degree of local food production or local processing of the food;
c) means for assigning a score to each assessment; and
d) means for combining each score into a total rating;
wherein the total rating is an amount that exists on a sliding scale and can be compared to total ratings of other food.

16. The general purpose computer of claim 15, wherein the computer is a smartphone.

17. The general purpose computer of claim 16, further comprising means for assessing the degree of local sources of ingredients and assigning a score to this assessment to be combined with the scores from the other assessment to provide the total.

18. The general purpose computer of claim 15 further comprising means for assessing the sustainability of the food and assigning a score to this assessment to be combined with the scores from the other assessment to provide the total.

19. The general purpose computer of claim 15 further comprising means for linking the total rating of the food from a food label to a consumer.

20. The general purpose computer of claim 19, wherein the linking means comprises an information code on the label to be scanned by a consumer using a scanning device.

21. The general purpose computer of claim 20 wherein the information code comprises a QR code.

22. The general purpose computer of claim 15, further comprising means for assessing the degree of local sources of ingredients and assigning a score to this assessment to be combined with the scores from the other assessment to provide the total.
